(19) United States
(12) Patent Application Publication
(10) Pub. No.: US 2008/0250315 A1
(43) Pub. Date: Oct. 9, 2008

(54) GRAPHICAL REPRESENTATION FOR ACCESSING AND REPRESENTING MEDIA FILES

(75) Inventors: Antti Eronen, Tampere (FI); Jukka Holm, Tampere (FI); Arto Lehtiniemi, Lempaala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/697,904

(22) Filed: Apr. 9, 2007

(51) Int. Cl. G06F 3/048

(52) U.S. Cl. 715/706; 715/767

(57) ABSTRACT

A method, an electronic device, and a computer program product are provided for creating a graphical presentation for accessing and representing one or more media files. According to one embodiment, the method includes analyzing one or more media files associated with a user and generating at least one graphical representation representative of the one or more media files. The method further includes enabling a selection of at least a portion of the at least one graphical representation in order to access the one or more media files.

### FIELD OF INVENTION

Embodiments of the present invention relate generally to the process of interacting with and controlling various media files accessible by an electronic device and, to a graphical representation for use in this process.

### BACKGROUND OF THE INVENTION

People are increasingly storing and accessing more and more data files, such as audio, video, text and/or multimedia files, on their electronic devices (e.g., cellular telephones, personal digital assistants (PDAs), personal computers (PCs), and laptops). For example, many individuals store entire music collections in the form of MP3 files on their cell phones or other mobile devices. These individuals may then use some form of a music player implemented on their device to select and play back the songs from their collection.

In addition people can have a great variety of music files and, thus, musical genres in their mobile devices. Playlists (e.g., a list of songs) are usually defined manually, generated, or downloaded prior to actually listening to a playlist. When the user is in a certain mood, a suitable playlist does not necessarily exist to fit that mood, and the user may need to generate a new playlist.

In addition, various automatic music recommendation systems are gaining popularity, wherein these systems determine, based, for example, on a user's current music collection, or on specific information input by a user, a playlist that contains similar music to a track the user likes. An example of such a music recommendation system can be found at www.pandora.com.

Currently, however, accessing and controlling this multitude of media files can be quite tedious and somewhat boring. A need, therefore, exists for a more convenient and entertaining way of interfacing with various media files either stored on an electronic device or accessible to the electronic device over a communications network.

### BRIEF SUMMARY OF THE INVENTION

In general, various embodiments of the present invention may provide improvements over the prior art by, among other things, providing methods, electronic devices, and computer program products for accessing one or more media files and creating an avatar representative of a user's media files. Various embodiments of the present invention analyze a user's media files in order to create a graphical representation, such as an avatar, having an appearance that is representative of the media files, such as a human character representative of a user's entire music collection. The user is capable of interacting with the avatar in order to access the media files, such as by selecting a portion of the avatar to access media files associated with the appearance of the selected portion.

According to one aspect of the present invention, a method, an electronic device, and a computer program product are provided for accessing one or more media files (e.g., playlists). The method includes analyzing one or more media files associated with a user and generating at least one graphical representation, such as an avatar, representative of the one or more media files. The method further includes enabling a selection of at least a portion of the at least one graphical representation in order to access the one or more media files.

According to aspects of the method, generating a graphical representation includes generating at least one avatar image of a human character representing the one or more media files. The one or more media files may be associated with particular portions of the human character and may be indicative of the appearance of the human character.

In the instance where the media files are playlists, the method enables the user to select at least a portion of the at least one graphical representation, such as an avatar, in order to generate one or more playlists. In addition, enabling the selection may include enabling the selection of at least a portion of the at least one graphical representation to play audio files, browse audio files, receive recommended audio files, and/or purchase audio files.

According to further aspects of the method, the analysis of the media files may include analyzing one or more media files when the one or more media files are copied, downloaded, or purchased by the user. Moreover, the analysis of the media files may include determining a frequency and/or contemporaneousness that the user has accessed the more or more media files. The analysis of the media files may also include retrieving meta-data describing one or more attributes associated with the one or more media files.

According to a further aspect of the present invention, an electronic device is provided that is capable of creating at least one graphical representation, such as an avatar, for accessing one or more media files. The electronic device includes an input device, a processor in communication with the input device, and a memory in communication with the processor. The memory may, in turn, store an application executable by the processor, that is capable, upon execution, of: (1) analyzing one or more media files associated with a user; (2) generating at least one graphical representation representative of the one or more media files; and (3) enabling the selection of at least a portion of the at least one graphical representation with the input device in order to access the one or more media files.

Another aspect of the present invention provides a computer program product for creating a graphical representation, such as an avatar, for accessing one or more media files. The computer program product includes at least one computer-readable storage medium having computer-readable program code portions stored therein. The computer-readable program code portions include: (1) a first executable portion for analyzing one or more media files associated with a user; (2) a second executable portion for generating at least one graphical representation representative of the one or more media files; and (3) a third executable portion for enabling the selection of at least a portion of the at least one graphical representation in order to access the one or more media files.

An additional embodiment of the present invention provides a method, an electronic device, and a computer program product for creating a graphical representation, such as an avatar, for representing a plurality of media files. For example, the method includes analyzing one or more media files (e.g., a playlist) associated with a user and generating at least one graphical representation (e.g., an avatar) representative of the media files. The media files are associated with particular portions of the at least one graphical representation and are indicative of an appearance of the at least one graphical representation. The method could further include enabling the selection at least a portion of the at least one graphical representation in order to access one or more of the media files.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1 and 2 represent screen shots of an avatar generated by an electronic device for accessing and representing media files either stored on or accessible by an electronic device in accordance with various embodiments of the present invention;

FIG. 3 represents flowcharts illustrating the creation and modification of an avatar according to one embodiment of the present invention;

FIG. 4 is a flowchart illustrating the interaction with an avatar according to an embodiment of the present invention;

FIGS. 5-7 represent screen shots of various avatars generated by an electronic device for interacting with the avatars according to various embodiments of the present invention;

FIG. 8 represents flowcharts illustrating the modification of an avatar according to an embodiment of the present invention;

FIG. 9 is a block diagram of one type of system that would benefit from various embodiments of the present invention; and

FIG. 10 is a schematic block diagram of a mobile station capable of operating in accordance with various embodiments of the present invention.

### DETAILED DESCRIPTION OF THE INVENTION

The present inventions will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Overview:

In general, various embodiments of the present invention provide a graphical representation, such as an avatar, for accessing and presenting media files, such as music, video, text or multimedia files, or the like, either stored on an electronic device or accessible by the electronic device via, for example, a communications network. According to one embodiment, at least a portion of the avatar may be used as an interface to one or more media files or a collection of media files, as well as used for some specific function for interacting with and controlling the media files and collection of media files (e.g., in the instance where the media files comprise audio files, e.g., play audio files, browse audio files, receive recommended audio files, and purchase audio files).

In one embodiment, the media files are represented as an avatar representative of a human character. The appearance of the avatar may be based on the media files and/or the activity of the user. For example, in the instance where the avatar is used for interfacing with audio files, the appearance of the avatar may be based on song, artist or album name, musical genre, or a playlist related to a certain topic (e.g., an 80's party). Aspects of the appearance may include for example, various objects, such as hair, clothing, posture, and size of the avatar, to name a few. The appearance may be customized by the user, and new elements may be downloaded from the Internet or otherwise provided to the user. In addition, the activity of the user, such as the frequency that the user accesses and/or uses the media files and the contemporaneousness of such access and/or use may be used to create the appearance of the avatar.

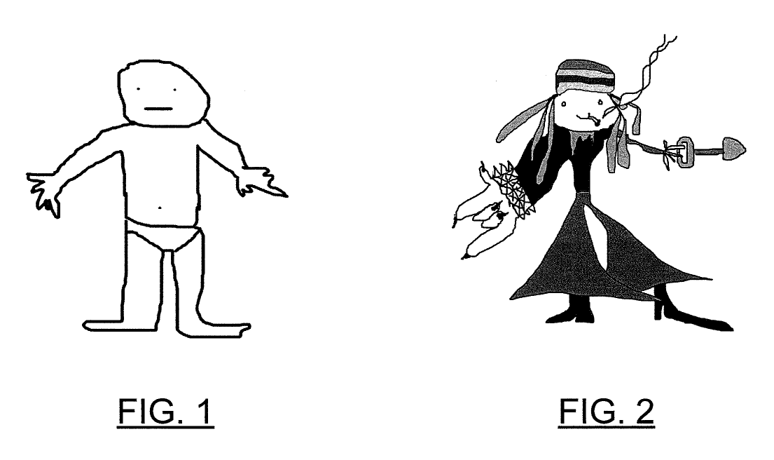

FIGS. 1 and 2, depicting various aspects of the invention, illustrate graphical representations, such as avatars, that may be created in accordance with various embodiments of the present invention for accessing and representing various media files. As one of ordinary skill in the art will recognize, the following is provided for illustration purposes only and should not be taken in any way as limiting the scope of the present invention. Thus, although the avatar is discussed in the context of a human character, the avatar could be any suitable graphical interface for allowing the user to access the media files, as well as represent the media files. Furthermore, although the media files are described as audio or music files below, the media files may be any media file, such as music, video, image, book, journal, collectible card, text or multimedia files, or the like, or any data file. Additionally, the graphical representation may be any representation like a room, a building, a car, a garden, a collage, or the like having dynamically amendable and attachable elements.

### Representing Media Files as an Avatar:

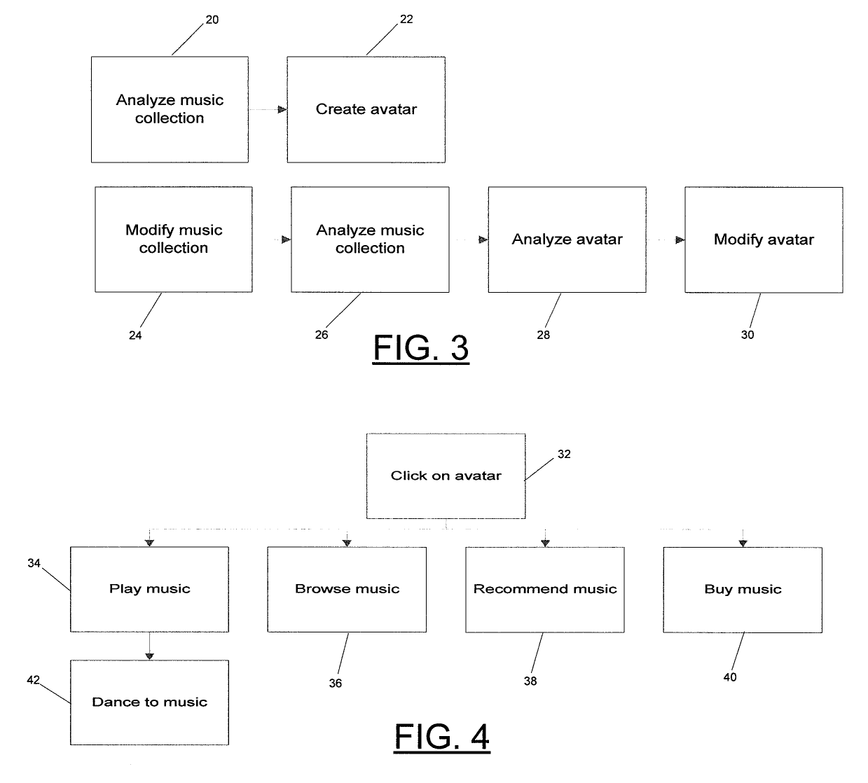

Various embodiments of the present invention may be used to create an avatar for accessing and controlling various audio files stored on a user's electronic device (e.g., as part of the user's music collection). In one embodiment, the user will be presented with a blank, lifeless character that does not include any clothing or accessories, as shown in FIG. 1. However, as shown in FIG. 3, the user's collection of media files, such as audio files, may be analyzed for relevant musical features in order to create (blocks 20-22) or modify (blocks 24-30) the appearance of the avatar. In addition, the appearance of the avatar may be created or modified when the user, for example, copies, downloads, accesses, uses, or purchases media files. Various information, such as meta-data information, associated with the audio files that may be analyzed or otherwise retrieved, such as, for example: artist and album names; percentage of songs belonging to a certain genre compared to the whole collection (e.g., a collection could include 50% of heavy metal songs and 50% of country songs); tempo of songs in beats per minute (BPM); average energies of songs; most listened to genres, artists, albums, and songs; recently listened to genres, artists, albums, and songs; and/or country of origin of the songs. Additionally, an avatar may be defined by user specific and/or selected preferences, such as the user's age, gender, race, nationality, etc. Moreover, although the avatar of FIG. 1 is shown as initially having no appearance associated with the user's media files, the avatar may be initially defined with some personality features such that the initial character features may be modified based on the user's collection of media files.

The appearance of the avatar may be created to represent a user's entire collection of media files or a portion of the user's media files. One or more avatars may be generated to represent various aspects of the user's media files so that one avatar may represent the whole media collection, and one or more other avatars may represent one or more subsets of the whole media collection, such as music collection, video collection, different play lists, different genres, or the like, so that the avatars may create a family, a gang, or the like. Any number of features may be employed to customize the appearance of any avatars. For example, the length and width of the avatar, gender of the user or avatar, facial hair (e.g., moustache or beard), shape and size of the avatar's head, eyes, nose, mouth, ears, and jaw, facial expressions, make-up, earrings, nose rings, tattoos, piercings, the shape and size of the avatar's body, the shape and size of the avatar's hands and feet, the shape and size of the avatar's stomach, glasses, sunglasses, rivets, jewelry, scarves, hats, jackets, t-shirts, jeans, boots, bags, text or image on an article of clothing (e.g., hat, t-shirt, etc.), and tools, or personal portable electronic devices, and other accessories.

Furthermore, the appearance of the avatar may be modified by various parameters determined by analyzing the user's collection of media files, as depicted in FIG. 3. For instance, the size of the user's music collection may affect the overall size of the avatar. The user's most listened to genres may affect the size of the avatar's legs, arms, and clothing, and recently listened to genres may affect aesthetic features of the avatar, such as the appearance of the avatar's hair, face, and head. Other parameters associated with the user's collection of media files that may affect the appearance of the avatar include: most/recently listened to/favorite artist name may affect the text on an article of clothing (e.g., t-shirt or hat); most/recently listened to/favorite genre may affect the size of the avatar's tools and accessories; the number of songs from some genres may affect the size of the avatar's legs, arms, and clothing; the number of songs from the most listened to/biggest genre may affect the size of the avatar's stomach; the number of songs from other popular/big genres may affect the size of the avatar's legs, arms, and clothing; an energetic song/album/genre may generate an angry face on the avatar; and clothes/scars/etc. on the backside of the avatar may indicate genres/artists/albums/songs that the user has not listened to for a long time.

FIG. 2 demonstrates one potential example of what a resulting avatar could look like. In this regard, the avatar shown in FIG. 2 is not very tall, so the owner of this collection may not own very many albums. The avatar's head looks like a rastafari, so the user may have been listening to reggae music recently. Based on the appearance of the avatar's right arm (black and thick with rivets), the user may listen to heavy metal. The avatar has a thin left arm and a shovel, so the user may also listen to country. Based on the brown trumpet jeans and high-heeled shoes, the user may also listen to funk or disco music.

As shown in FIG. 3, illustrating one aspect of the invention, when the user modifies his or her collection of media files (e.g., adds media files to the collection) (block 24), the new media files may be analyzed for the same or similar features as the original collection (block 26). The media files may be analyzed and modified dynamically and in real time, such that the media files may be analyzed as media files are modified. When the modified collection of media files is analyzed, the avatar is analyzed (block 28) to determine if the avatar is to be modified (block 30) based on the modifications to the media files. Some features (e.g., genre percentages of the total media collection) may be recalculated for the entire collection of media files. Additionally, features of the new media files may be emphasized over other features for some period of time, e.g., if a person has downloaded a CD of Bob Marley, a T-shirt with Bob's image may be displayed for some period of time (e.g., a week).

Other similar descriptive information may likewise be accessed in accordance with various embodiments of the present invention. For example, meta-data may be used to analyze the user's collection of media files. Meta-data relating to music and other media files may comprise media content descriptive meta-data, such as that described in the MPEG-7 standard by the Moving Picture Experts Group. For music, these meta-data descriptors may relate, for example, to the melody and timbre of the music. For images, they may relate, for example, to the dominant color or shape. The meta-data may also be generated by the user, for example, when analyzing the user's collection of media files, or the meta-data may be requested and delivered from a service provider. In one embodiment, the meta-data may describe the mood of the music, such as romantic, danceable, aggressive, or the like. In another embodiment of the present invention, the meta-data may describe the tempo of music (e.g., in beats per minute (BPM)). The tempo of music could be analyzed using various techniques, such as those disclosed in pending U.S. patent application Ser. No. 11/405,890, entitled Method, Apparatus and Computer Program Product for Providing Rhythm Information from an Audio Signal, filed Apr. 18, 2006, which is assigned to the present assignee and incorporated herein by reference.

The appearance of the avatar may be based on any number of aspects of the user's media files. Depending on the user's collection of media files, portions of the avatar (e.g., head, arms, legs, clothing, etc.) could then be representative of specific media files. For example, the user's eight most popular/biggest/recently listened to genres could be used to represent the appearance of the avatar. The number of possible variations of the appearance of the avatar may be limited in order to simplify the implementation and appearance of the avatar. Also, the ability to support hundreds of different genres may be impractical, so aspects of the user's media files could be grouped in various categories. For instance, the genres of the media files could be grouped into a limited number of main genres such as jazz, heavy metal, rock, world, classical, and so on. If the analysis of media files involves reading music genre information from MP3 meta-data (e.g., ID3 standard), each ID3 genre could become a sub-group of a major genre. An ID3 tag is a set of meta-data in an MP3, or similar, audio file that describes its contents, including song title, artist, album, year, comment, CD track and genre. ID3 tags are used for searching, as well as for displaying the song title of the audio file being played. ID3 tags reside at the end of the file and comprise 128-bytes divided into six fields (track name, artist name, album name, year, comment and genre).

According to another aspect of the present invention, the avatar may be associated with various additional items for accessing or storing media files. For example, the avatar may own a closet or other type of furniture that can be used for storing the least listened to genres, artists, and albums. In addition, by taking some clothes off, the user could indicate that this type of media file should be moved to the closet for later use. By taking some clothes from the closet and putting them on the avatar, the user can create shortcuts to media files to be accessed immediately or in the near future.

According to another aspect of the present invention, the user may indicate which portion of the avatar should correspond to a particular musical genre or attribute. For example, when new media types (e.g., new music genres) are detected, the user may be notified of the new media types and be requested to select a portion of the avatar (e.g., the stomach, hand, leg, etc.) that may correspond to the new media type. In an alternative implementation, the portion of the avatar representing a particular media type is automatically selected. In another alternative implementation, the media categories are initially allocated to different portions of the avatar, and the user is able to change the initial allocations (e.g., change the heavy metal genre from the hand to a leg). The selection and changing could be performed, for example, by clicking a portion of the avatar and selecting an option “change location” and then dragging the portion to a new location.

According to another aspect of the present invention, the user may create shortcuts to various media files by adding different accessories or tattoos to the avatar. As an example, the user may draw or ad by other means a heartogram symbol as a tattoo on the arm of the avatar, and create a shortcut to the music by the Finnish rock band HIM. As another example, the user might add large earrings to the avatar and create a shortcut to the music of Bonnie Tyler. The shortcut would be enabled the next time the user clicks on the shortcut.

The audio files could be analyzed on the user's electronic device, or the information could be requested from a service provider. Thus, information identifying an audio file may be communicated to the service provider, and the service provider may then communicate information associated with the audio file back to the electronic device (e.g., meta-data). The meta-data received from the service provider may be stored to a meta-data database stored locally in the memory of the electronic device. Alternatively, the application that is capable of analyzing various audio files and functions for interacting with the audio files may be stored exclusively in memory on the electronic device. The user may, therefore, use the avatar in order to control his or her media files regardless of whether he or she is currently connected to a communications network.

Interacting with an Avatar:

Embodiments of the present invention enable a user to interact with an avatar to access and/or control one or more media files. For example, the user is capable of selecting particular portions of the avatar in order to access one or more media files. The user may select a portion of the avatar based on an appearance of the selected portion in order to access one or more media files. For example, FIG. 4, depicting one aspect of the invention, illustrates a flowchart for enabling a user to interact with an avatar to access audio files according to one embodiment of the present invention. By clicking on a certain portion of the avatar (block 32), the user can play music (block 34), browse music (block 36), receive music recommendations (block 38), and/or buy music (block 40). In other words, if the user clicks on a particular portion of the avatar (e.g., the avatar's cowboy hat) the electronic device may play country music for the user. The avatar could also dance to the tempo of the music (block 42). The dance movements can be generic or specific to a certain genre. In addition or in the alternative to accessing the user's own collection of media files from the user's electronic device, media files could also be downloaded or streamed to the electronic device from a service provider (e.g., commercial music service).

Various techniques may be employed to access the media files associated with a particular location of the avatar. For example, when the user selects a particular portion of the avatar, the coordinates (e.g., X and Y) of the position of the cursor on the screen may be retrieved. The coordinates corresponding to the selected portion of the avatar (e.g., the left arm) may be located, and information from a mapping file may be retrieved in order to indicate which media file corresponds to the selected portion. As an illustrative example, a mapping file could indicate “right arm—>genre heavy metal,” “head—>genre reggae,” “left arm—>genre country,”“legs—>genre 70's disco and genre funk.” In this instance, when the user selects the location which corresponds to the left arm, the media files associated with the country music genre are retrieved and may be accessible to the user. Any number of attributes may be represented in the mapping file, such as “left arm—>artist XYZ,” “left foot—>mood romantic,” or “tattoo—>album LMN.”

Instead of accessing a single media file after each selection, the user may access one or more collections of media files (e.g., playlists). For example, the user may select a certain part of the avatar to create a playlist. The playback of the playlist may start automatically from the beginning of the playlist and last as long as all the songs have been played through, the user presses stop, or clicks on another part of the avatar to create a new playlist. In addition, the user can also create more complicated playlists by selecting several parts of the avatar in sequence. As an example, selecting a cowboy hat three times, long hair twice, and disco boots once could add several country, a couple of heavy metal, and only a few disco songs to a playlist.

According to another aspect of the present invention, the user could generate a transition playlist. For example, the user may draw a curve with an input device on the avatar to generate a playlist. Referring to FIG. 2, the user may draw a curve with an input device from the left hand via the head and hat to the right hand. Drawing the curve could result in generating a playlist that starts with country music (corresponding to the left hand), continues with reggae music (the head and hat), and ends with heavy metal music. To indicate that the user wishes to make a transition playlist and not, for example, move the position of the avatar when moving the cursor on or near the avatar, there may be an option where the user may right click a mouse on top of the avatar, which may provide the user with several options, such as “generate transition playlist” or “change position.”

In addition to clicking a certain part of the avatar, the user can also interact with the avatar by modifying the appearance of the avatar. For example, the user may affect the contents of a playlist by changing the avatar's posture. The postures can be mapped based on musical tempo. Thus, if the avatar is in a lazy position, slow music may be added to the playlist, while if the avatar looks energetic, the playlist may contain higher tempo music. According to one example, the user may be provided with options for modifying the position of the avatar using an input mechanism, such as when the user clicks the right mouse button on top of the avatar. One of the options may be “change position.” When the user selects the change position option, he or she may click and drag a part of the avatar into a new position. In another example, a menu may be presented to the user where the user may select the option “change position” and then select the new position, such as from a pull down menu with several options (e.g., “lie down,” “stand up,” “sit,” “run,” “sleep,” etc.).

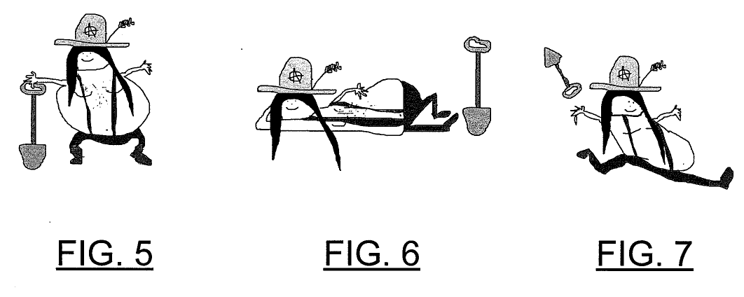

FIGS. 5-7, showing various aspects of the invention, depict three potential postures for an avatar according to one aspect of the present invention. Based on the avatar's appearance, the user may have a large collection of country music (i.e., hillbilly appearance and a large stomach) but also enjoys heavy metal (i.e., long, dark hair), punk (i.e., anarchy sign on the hat), and glam rock (i.e., pink boots) music. The original posture of the avatar is shown in FIG. 5. If the user clicks on a particular portion of the avatar (e.g., the pink boots), corresponding music with a moderate tempo (e.g., 80<BPM<150) is added to the playlist. If the user changes the avatar's posture as shown in FIG. 6 (i.e., the avatar is now lying down) and selects a particular portion of the avatar, slower tempo music from the corresponding genre may be added to the playlist. By modifying the posture of the avatar to the position shown in FIG. 7 and selecting a particular portion of the avatar, faster tempo music is added to the playlist. Various other techniques could be employed to modify the appearance of the avatar and, thus, the type of media files selected. For example, moving the avatar's hands up or down could result in adding fast or slow music to a playlist. In addition to BPM value, dance movements may also depend on the posture of the avatar. As an example, the posture of the avatar shown in FIG. 5 could result in “normal” dancing movements, the posture shown in FIG. 6 could result in only moving the left foot and nodding the head, and the posture shown in FIG. 7 could result in wild jumping from one side of the screen to another.

In one alternative implementation of the invention, clicking on the avatar does not automatically add songs to a playlist and start the music playback. Instead, a list of songs, subgenres, artists, albums, etc. that are associated with a particular portion of the avatar may be shown on the user's electronic device. The list may include songs from the user's own collection or from a service provider. Subsequently, the user can make further selections from the list using the electronic device's input device (e.g., using a keypad or joystick).

Yet another alternative implementation would be to use the avatar as a shortcut to a service provider. For instance, by clicking a country hat on the avatar, the country section of a music service could be provided to the user's electronic device such that the user could then select and buy new music from the service provider. In addition, the user could also receive new genre specific clothes/accessories/dance movements/etc. for the avatar free of charge when the user buys a certain amount (e.g., one album) of new music from a certain genre. If the user buys large amounts of music from a certain artist, the user could receive artist specific attributes for the avatar (e.g., a t-shirt with that artist's name, or the avatar's face could be replaced with that artist's face). The service provider could also provide the user recommendations for media files based on the user's collection of media files or media files that the user has selected.

In yet another example, an Internet music store or an online music purchasing application running on a mobile computer may provide a preview option which would allow the user to preview changes in the appearance of the avatar or other graphical representation in the instance where the user is deciding whether to buy certain music. For example, a user might select an album and see what the avatar would look like if the user was to buy the particular album. The avatar could be modified based on the particular album to be added to the collection of media files of the user. Thus, the user is capable of visually previewing the user's avatar as changes in the contents of the user's collection of media files are made. This feature may be useful for users who choose to develop the visual appearance of the avatar or their musical taste towards a certain goal (e.g., more heavy metal or other aggressive music). If the user is satisfied with the changes, the user could then purchase the music, or if the user is not satisfied, choose not to purchase the music. In the latter case, the appearance of the avatar would be restored as it was before the preview.

Yet another alternative implementation would be to use the avatars to illustrate other types of music content in addition to illustrating a user's personal music collection. For instance, avatars could be used to display the most popular songs in Internet music stores. Instead of viewing a typical Top 10 list, the user could have the option to view the list using an avatar. Different portions of the avatar could correspond to different Top 10 songs. For example, if the number one song is a heavy metal song, the avatar could have a beard and long black hair and perhaps some accessories that would resemble the attributes of the number 1 band. The right and left arms could correspond to, and appear like, the number two and three songs, respectively, the stomach could correspond to the number four song, the legs could correspond to the number five and six songs, respectively, and the gloves and shoes could correspond to the number seven to ten songs. As another example, clubs and discos could show their playlist with an adaptive avatar, and people could decide by looking at the avatar if they want to enter. Thus, by viewing the avatar the users could immediately determine what type of music is played in the disco. As a yet another example, avatars may also be used to illustrate the music files of a vehicle's stereo system (e.g., car stereo). The avatar could be used to control the car stereo system. In addition, an individual's car could be customized to display (e.g., liquid crystal display) media files in the car system that is viewable outside the car using an avatar. For example, the LCD display may operate as an external display attached to the car audio system or mobile music terminal and illustrate the avatar. Thus, people on the streets of a city could immediately see the music tastes of others by viewing the avatars on the displays mounted on the cars.

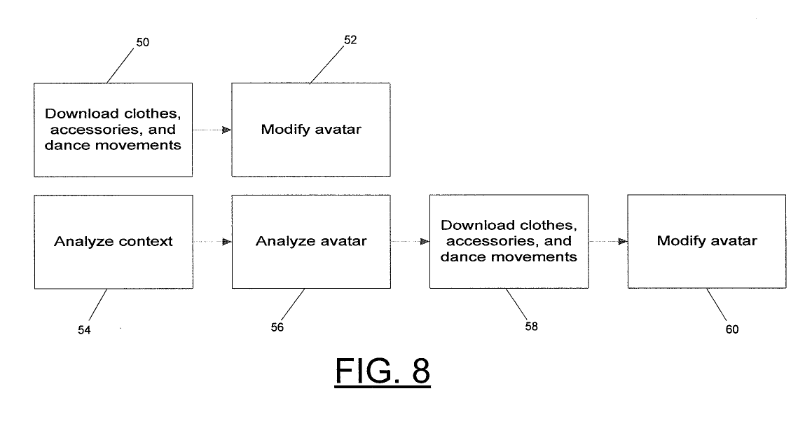

Additional aspects of the present invention enable the user to modify the appearance of the avatar in various ways, as shown in the flowcharts of FIG. 8. For example, the user may purchase and download new clothes, accessories, and/or dance movement templates (block 50) in order to modify the avatar (block 52). If the user is a fan of some genres or artists, and the appearance of the avatar does not change often, the user may periodically update the avatar's appearance. By connecting to a service provider, the user could buy new media files from those categories that the user currently has media files. For instance, in order to buy a new cowboy hat, the user may be required to have country music in the user's collection.

FIG. 8 illustrates another aspect of the invention for creating the appearance of the avatar using contextual information. In this regard, contextual information may be analyzed (block 54) to modify the avatar (block 60). The avatar is analyzed (block 56) in order to determine if the appearance of the avatar may be modified based on the contextual information, such as by downloading clothes, accessories, and/or dance movements (block 58). For example, if the original avatar is created during the summer, the avatar could originally wear light clothing. However, when winter arrives, recommendations for buying new, warmer clothes could be provided to the user, or the appearance of the avatar could be changed automatically. In addition, other possible variations include adding sunglasses to the avatar when it is a sunny day, using different clothes depending on time of the day or day of the week or depending on the setting, such as an office or social setting, or weather. Additionally, the media file (e.g., song or CD) may include or attach one or more apparel items or accessories related to the media file when the user purchases the media file such that the apparel or accessory item is accessible by a user's electronic device. These apparel or accessories may be included in a collection of the avatar's wardrobe or directly affect the appearance of the avatar. Furthermore, if user has been to a concert (or a movie) some apparel or accessories relating to the concert may be received and worn by the avatar.

Another example of using contextual information is related to pictures, videos, sounds, and other media recorded or acquired during traveling. Where the media files were recorded or acquired may be used to modify the avatar. For example, when the user is visiting Germany and takes pictures, shoots video, and/or buys music, the avatar may receive items related to Germany, such as leather pants or other traditional garment often worn in Germany, that may be selected by the user to access the travel pictures, videos, or media files linked to the particular trip or trips. As another example, when the user is visiting India, the avatar may receive a turban, through which the travel pictures can be accessed later on. Thus, the information acquired from the media files may be related to the location and situation in which the media files were recorded or acquired.

Yet another aspect of the present invention facilitates the use of an avatar in games and virtual worlds such as Habbo Hotel or Second Life. For example, by viewing an avatar, the other players can immediately see if their musical tastes (and possibly personalities as well) match with the user owning that avatar. In addition, music services/artists/record companies could create avatars representing their current offerings and move them in the virtual world. The avatars could be used as shortcuts to the services of the music services/artists/record companies or simply as advertisements. Moreover, recommendation services could chat with avatars, e.g. “Hey, this new cowboy hat would look cool on you!” (recommending new country music to the avatar). By exchanging clothes with another avatar, the corresponding media files could be transferred from one user to another. If the files are music files and DRM protected, the rights to the music files may be transferred from one user to another. Furthermore, if two avatars spend lot of time together, a third avatar may be created that looks like a mixture (i.e., a child) of the original avatars. The child may look more like the user having the larger collection of media files. Both parents may be responsible for “taking care” of the new avatar, i.e., its appearance changes according to modifications made to the parent avatars. One potential benefit from the creation of such “child avatars” is the creation of new playlists. For instance, when a child avatar is created, it will possess information of the music of both its parents. The user may create new playlists that combine the music of both parents by clicking of the parts of the child avatar, or make a transition playlist by drawing a pattern on top of the child avatar.

### Overall System and Electronic Device:

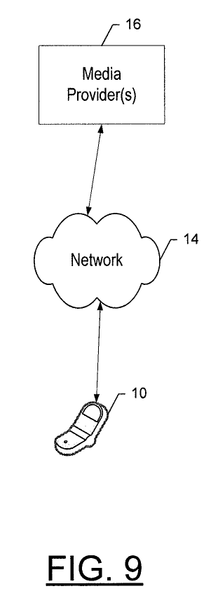

Referring to FIG. 9, showing one aspect of the invention, an illustration of one type of system that would benefit from embodiments of the present invention is provided. As shown in FIG. 9, the system may include one or more electronic devices 10 in communication with one or more media providers 16 over a communications network 14 for the purpose of accessing and/or obtaining media files at the electronic device 10. In general, therefore, the electronic device 10 of one embodiment may be capable of accessing and downloading media files from the media provider(s) 16. As is discussed in more detail below, according to various embodiments of the present invention, the electronic device 10 may store an application capable of creating an avatar for use when interfacing with the avatar in order to access and control not only various media files stored on the electronic device 10, but also media files accessed by the electronic device 10 via the media provider(s) 16.

The electronic device may comprise any wired or wireless communication device capable of storing and/or accessing various media files, such as, for example, a cellular telephone, personal digital assistant (PDA), pager, mobile communication device, personal computer (PC), laptop, tablet, television, set-top box (STB), digital video recorder (DVR), audio/video player, digital camera/camcorder, digital/AM/FM radio, positioning device (such as Global Positioning System (GPS) device) or other similar device, or any combination of the aforementioned. The communications network may comprise any wired or wireless network including, for example, a personal area network (PAN), a local area network (LAN), a metropolitan area network (MAN), and/or a wide area network (WAN).

The communications network may be capable of supporting communication in accordance with any one or more of a number of first-generation (1G), second-generation (2G), 2.5G and/or third-generation (3G) mobile communication protocols or the like. For example, one or more electronic devices may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

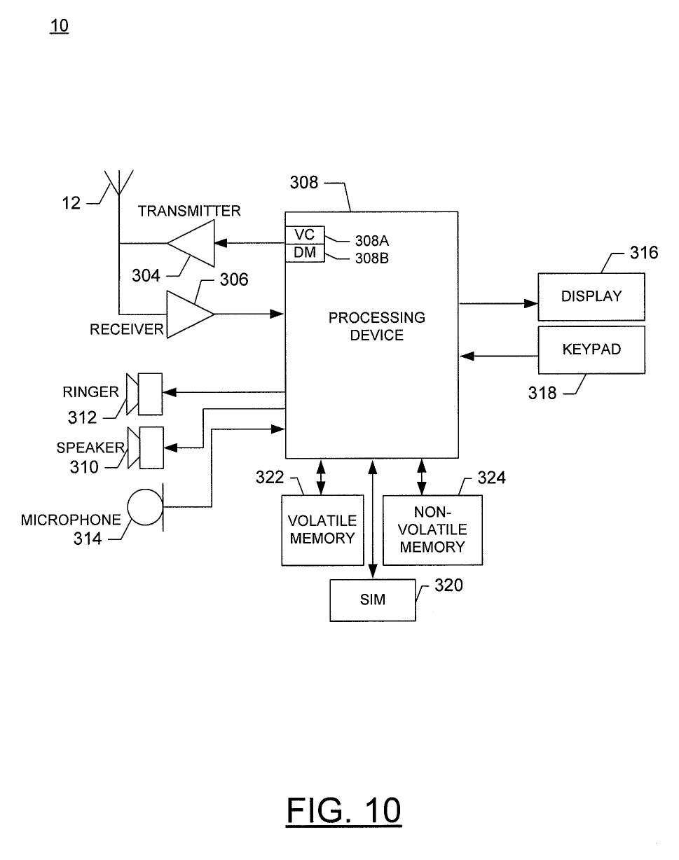

Reference is now made to FIG. 10, which illustrates one type of electronic device 10 that would benefit from embodiments of the present invention. For example, FIG. 10 illustrates a mobile device including various means for performing one or more functions in accordance with various embodiments of the present invention. It should be understood, however, that the mobile device illustrated and hereinafter described is merely illustrative of one type of electronic device that would benefit from the present invention and, therefore, should not be taken to limit the scope of the present invention. Other types of mobile devices, such as personal digital assistants (PDAs), laptop computers, as well as other types of electronic devices including both mobile, wireless devices and fixed, wireline devices, can readily employ embodiments of the present invention.

As stated above, the mobile device includes various means, such as a processor operating under control of software, for performing one or more functions in accordance with various embodiments of the present invention, including those shown and described herein. It should be understood, however, that one or more of the entities may include alternative means for performing one or more like functions, without departing from the spirit and scope of the present invention. For example, as shown in FIG. 10, in addition to an antenna 12, the mobile device 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile device can be capable of operating with one or more air interface standards, communication protocols, modulation types, and access types. For example, the mobile device can be capable of operating in accordance with any of a number of second-generation (2G), 2.5G and/or third-generation (3G) communication protocols or the like. Further, for example, the electronic device can be capable of operating in accordance with any of a number of different wireless networking techniques, including RFID (radio-frequency identification), Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the electronic device and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a joystick (not shown), a microphone 314, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile device may include a battery, such as a vibrating battery pack, for powering the various circuits that are required to operate the electronic device, as well as optionally providing mechanical vibration as a detectable output.

The mobile device can also include means, such as memory including, for example, a subscriber identity module (SIM) 320, a removable user identity module (R-UIM) (not shown), or the like, which typically stores information elements related to a mobile subscriber. In addition to the SIM, the electronic device can include other memory. In this regard, the electronic device can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code executable by the controller 308 for creating an avatar representative of various media files, also stored in the memory or otherwise accessible by the mobile device, and functions for accessing and controlling those media files, such that a user is able to interact with the avatar as described above using, for example, one of the above-referenced input devices, in order to effect the performance of various functions with respect to the media files.

The system, method, electronic device, network entity and computer program product of various embodiments of the present invention are primarily described in conjunction with mobile communications applications. It should be understood, however, that the system, method, network entity and computer program product of embodiments of the present invention can be utilized in conjunction with a variety of other applications, both in the mobile communications industries and outside of the mobile communications industries. For example, the system, method, electronic device, network entity and computer program product of various embodiments of the present invention can be utilized in conjunction with wireline and/or wireless network (e.g., Internet) applications.

### CONCLUSION

As described above and as will be appreciated by one skilled in the art, embodiments of the present invention may be configured as a system, method or network entity. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Various embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
analyzing one or more media files associated with a user;
generating at least one graphical representation representative of the one or more media files; and
enabling a selection of at least a portion of the at least one graphical representation in order to access the one or more media files.

2. The method of claim 1, wherein generating comprises generating at least one avatar image of a human character representing the one or more media files, and wherein one or more of the media files are associated with particular portions of the human character and are indicative of an appearance of the human character.

3. The method of claim 1, wherein the one or more media files comprise playlists each comprising a plurality of audio files.

4. The method of claim 3, wherein enabling comprises enabling a selection of at least a portion of the at least one graphical representation in order to generate one or more playlists.

5. The method of claim 3, wherein enabling comprises enabling a selection of at least a portion of the at least one graphical representation to at least one of play audio files, browse audio files, receive recommended audio files, and purchase audio files.

6. The method of claim 1, wherein analyzing comprises analyzing one or more media files when the one or more media files are copied, downloaded, or purchased by the user.

7. The method of claim 1, wherein analyzing comprises determining at least one of a frequency and a contemporaneousness of accessing the more or more media files by the user.

8. The method of claim 1, wherein analyzing comprises retrieving meta-data describing one or more attributes associated with the one or more media files.

9. A method comprising:
analyzing one or more media files associated with a user; and
generating at least one graphical representation representative of the one or more media files, wherein the one or more media files are associated with particular portions of the at least one graphical representation and are indicative of an appearance of the at least one graphical representation.

10. The method of claim 9, wherein the graphical representation comprises an avatar.

11. The method of claim 9 further comprising:
enabling a selection of at least a portion of the at least one graphical representation in order to access one or more media files.

12. The method of claim 9, wherein generating comprises generating at least one avatar image of a human character representing the one or more media files.

13. The method of claim 9, wherein of the one or more media files comprises at least one playlist, each playlist comprising a plurality of audio files.

14. The method of claim 9, wherein analyzing comprises analyzing one or more media files when the one or more media files are copied, downloaded, or purchased by the user.

15. The method of claim 9, wherein analyzing comprises determining at least one of a frequency and a contemporaneousness of accessing the one or more media files by the user.

16. The method of claim 9, wherein analyzing comprises retrieving meta-data describing one or more attributes associated with the one or more media files.

17. An electronic device comprising:
an input device;
a processor in communication with the input device; and
a memory in communication with the processor, the memory storing an application executable by the processor, wherein the application is capable, upon execution, of:
analyzing one or more media files associated with a user;
generating at least one graphical representation representative of the one or more media files; and
enabling a selection of at least a portion of the at least one graphical representation with the input device in order to access the one or more media files.

18. The electronic device of claim 17, wherein the application is capable, upon execution, of generating at least one avatar image of a human character representing the one or more media files, and wherein one or more of the media files are associated with particular portions of the human character and are indicative of an appearance of the human character.

19. The electronic device of claim 17, wherein the application is capable, upon execution, of enabling the user to select at least a portion of the at least one graphical representation to at least one of play audio files, browse audio files, receive recommended audio files, and purchase audio files.

20. The electronic device of claim 17, wherein the application is capable, upon execution, of analyzing one or more media files when the one or more media files are copied, downloaded, or purchased by the user.

21. The electronic device of claim 17, wherein the application is further capable, upon execution, of determining at least one of a frequency and a contemporaneousness of accessing the more or more media files by the user.

22. The electronic device of claim 17, wherein the application is capable, upon execution, of retrieving meta-data describing one or more attributes associated with the one or more media files.

23. The electronic device of claim 17 further comprising:
means for analyzing one or more media files associated with a user;
means for generating at least one graphical representation representative of the one or more media files; and
means for enabling a selection of at least a portion of the at least one graphical representation with the input device in order to access the one or more media files

24. An electronic device comprising:
an input device;
a processor in communication with the input device; and
a memory in communication with the processor, the memory storing an application executable by the processor, wherein the application is capable, upon execution, of:
analyzing one or more media files associated with a user; and
generating at least one graphical representation representative of the one or more media files, wherein the one or more media files are associated with particular portions of the at least one graphical representation and are indicative of an appearance of the at least one graphical representation.

25. The electronic device of claim 24, wherein the graphical representation is an avatar.

26. The electronic device of claim 24, wherein the application is further capable, upon execution, of enabling a selection of at least a portion of the at least one graphical representation in order to access one or more media files.

27. The electronic device of claim 24, wherein the application is capable, upon execution, of generating at least one avatar image of a human character representing the one or more media files.

28. The electronic device of claim 24, wherein the application is capable, upon execution, of retrieving meta-data describing one or more attributes associated with the one or more media files.

29. The electronic device of claim 24 further comprising:
means for analyzing one or more media files associated with a user; and
means for generating at least one graphical representation representative of the one or more media files, wherein the one or more media files are associated with particular portions of the at least one graphical representation and are indicative of an appearance of the at least one graphical representation.

30. A computer program product comprising:
a first executable portion for analyzing one or more media files associated with a user;
a second executable portion for generating at least one graphical representation representative of the one or more media files; and
a third executable portion for enabling a selection of at least a portion of the at least one graphical representation in order to access the one or more media files.

31. The computer program product of claim 30, wherein the second executable portion comprises instructions for generating at least one avatar image of a human character representing the one or more media files, and wherein one or more of the media files are associated with particular portions of the human character and are indicative of an appearance of the human character.

32. The computer program product of claim 30, wherein the third executable portion comprises instructions for enabling a selection of at least a portion of the at least one graphical representation to at least one of play audio files, browse audio files, receive recommended audio files, and purchase audio files.

33. The computer program product of claim 30, wherein the first executable portion comprises instructions for analyzing one or more media files when the one or more media files are copied, downloaded, or purchased by the user.

34. The computer program product of claim 30, wherein the first executable portion comprises instructions for determining at least one of a frequency and a contemporaneousness of accessing the more or more media files by the user.

35. The computer program product of claim 30, wherein the first executable portion comprises instructions for retrieving meta-data describing one or more attributes associated with the one or more media files.

36. A computer program product comprising:
a first executable portion for analyzing one or more media files associated with a user; and
a second executable portion for generating at least one graphical representation representative of the one or more media files, wherein the one or more media files are associated with particular portions of the at least one graphical representation and are indicative of an appearance of the at least one graphical representation.

37. The computer program product of claim 36, further comprising a third executable portion for enabling a selection of at least a portion of the at least one graphical representation in order to access one or more media files.

38. The computer program product of claim 36, wherein the second executable portion comprises instructions for generating at least one avatar image of a human character representing the one or more media files.

39. The computer program product of claim 36, wherein the first executable portion comprises instructions for analyzing one or more media files when the one or more media files are copied, downloaded, or purchased by the user.

40. The computer program product of claim 36, wherein the first executable portion comprises instructions for determining at least one of a frequency and a contemporaneousness of accessing the one or more media files by the user.

41. The computer program product of claim 36, wherein the first executable portion comprises instructions for retrieving meta-data describing one or more attributes associated with the one or more media files.
